(19) United States
(12) Patent Application Publication
(10) Pub. No.: US 2025/0190008 A1
(43) Pub. Date: Jun. 12, 2025

(54) INTERFACE CIRCUIT PORTIONS

(71) Applicant: Nordic Semiconductor ASA, Trondheim (NO)

(72) Inventor: Hans Olaf RYGH, Trondheim (NO)

(73) Assignee: Nordic Semiconductor ASA, Trondheim (NO)

(21) Appl. No.: 18/843,573

(22) PCT Filed: Mar. 3, 2023
(86) PCT No.: PCT/EP2023/055487

§ 371 Date: Sep. 3, 2024

(30) Foreign Application Priority Data
Mar. 4, 2022 (GB) 2203061.3

(51) Int. Cl. G06F 1/06; G06F 13/40

(52) U.S. Cl. CPC G06F 1/06; G06F 13/4004

(57) ABSTRACT

A system comprises a first circuit portion operating with a first clock having a first frequency, a second circuit portion operating with a second clock having a second, higher frequency, and an interface circuit portion for transferring data from the first and the second circuit portions. The first circuit portion is arranged to assert a data valid signal when asserting data at a data input. The data storage portion is configured to detect the data valid signal and to change an input data storage location of a shared memory in response thereto. The signalling portion is configured to change a state of an interface signal in response to the data valid signal. The data access portion is configured to change an output data storage location in response to the change of state of an interface signal and to output a data ready signal to the second circuit portion.

The present invention relates to interface circuit portions and methods of transferring data between circuit portions.

Electronic systems often comprise two or more clock domains—i.e. parts of the system that run at different clock frequencies. For instance, a Camera Serial Interface (CSI) camera may operate at a lower frequency than a host device on which image data from the camera is to be stored. It can be challenging to transfer data (e.g. the image data from the camera) between different clock domains (known as clock domain crossing), because there is no common clock with which a data transfer protocol can be synchronised. Data signals passed across clock domains without mitigation can become metastable, and without a common synchronised clock it can be difficult for a receiving circuit to know when the incoming data is valid to be sampled.

Conventional approaches to data transfer between clock domains include handshake protocols, in which each data bit sent on a data line is accompanied by a series of request and acknowledge control signals sent over separate handshake lines. Whilst reliable, this handshaking process can be relatively slow, especially when large amounts of data need to be transferred (e.g. for streaming image or video data). Other approaches include dual port RAM, in which one port can be used for writing and anther for reading. However, RAM is expensive and can take up a lot of physical space on a semiconductor device.

The applicant has recognised that improvements can be made to existing approaches to transferring data between clock domains.

When viewed from a first aspect, the present invention provides a system comprising:
a first circuit portion operating in a first clock domain with a first clock having a first frequency;
a second circuit portion operating in a second clock domain with a second clock having a second, higher, frequency; and
an interface circuit portion for transferring data from the first circuit portion to the second circuit portion, the interface circuit portion comprising:
   a data input arranged to receive data from the first circuit portion;
   a data output arranged to provide data to the second circuit portion;
   a shared memory comprising a plurality of data storage locations, at any given time one of said data storage locations being allocated as an input data storage location and one of said data storage locations being allocated as an output data storage location, wherein the shared memory is configured to store data asserted at the data input to the input data storage location, and to provide data stored at the output data storage location to the data output;
   a data storage portion;
   a signalling portion; and
   a data access portion;
wherein:
the first circuit portion is arranged to assert data at the data input and to assert a data valid signal when asserting data at the data input;
the data storage portion is configured to detect the data valid signal and to change the input data storage location in response to the data valid signal;
the signalling portion is configured to generate an interface signal and to change a state of said interface signal in response to the data valid signal; and
the data access portion is configured to detect the change of state of the interface signal, to change the output data storage location in response to the change of state of the interface signal and to output a data ready signal to the second circuit portion in response to the change of state of the interface signal.

It will be seen by those skilled in the art that an interface circuit portion in accordance with the invention can provide fast and reliable data transfer between clock domains. Advantageously, the interface signal produced by the signalling portion is a one-way signal that reliably indicates the presence of data in the shared memory to the second clock domain, mitigating the need for lengthy two-way handshake procedures.

Because the data access portion is configured to detect a change of state of the interface signal (e.g. rather than detecting an absolute state of the interface signal at a particular time), it does not require any information about the frequency or phase of the first clock to identify promptly and reliably when new data is being provided in the first clock domain. For instance, the data storage portion does not need to assess the state of the interface signal at a predetermined time related to the first clock to determine if data is present in the data storage. Instead, the data storage portion simply waits until the interface signal changes state, e.g. between two ticks of the second clock. The interface signal allows the data storage portion and data access portion to independently keep track of the currently allocated input and output data storage locations without the need for two-way communication.

The use of a shared memory comprising a plurality of data storage locations allows the interface circuit portion to buffer data from the first circuit portion until the second circuit portion has been informed of the presence of data with the interface signal. For instance, at a given time input data may be being stored to the data storage location currently allocated as the input data storage location whilst data is being retrieved from a different data storage location allocated as the output data storage location. This allows data to be transferred reliably between the first and second clock domains.

In a set of embodiments, the second circuit portion is arranged to access data at the data output in response to the data ready signal output by the data access portion.

The interface circuit portion may comprise elements in the first clock domain (i.e. clocked by the first clock) and/or elements in the second clock domain (i.e. clocked by a the clock). For instance, at least one of the shared memory, the data storage portion and the signalling portion may be in the first clock domain. The data access portion may be in the second clock domain.

In some embodiments, the number of data storage locations comprised by the shared memory corresponds to a propagation delay between the data valid signal being asserted and the change of state of the interface signal being detected by the data access portion (i.e. how long it takes for the indication of new data to propagate through to the data access portion). Preferably, the shared memory comprises at least as many data storage locations as a number of cycles of the first clock between the data valid signal being asserted and the change of state of the interface signal being detected by the data access portion. For instance, in some embodiments the signalling portion takes two cycles of the first clock to change a state of the interface signal in response to a data valid signal, and the shared memory comprises at least two data storage locations. In practice, due to additional latencies and delays the shared memory preferably comprises at least three data storage locations, or at least four data storage portions. In some embodiments the shared memory consists of four storage portions. It has been recognised that four storage portions are typically sufficient for a fast and reliable interface circuit portion, and adding additional storage portions may increase unnecessarily the size and/or cost of the interface circuit portion.

The data valid signal may comprise a distinct electrical signal sent from the first circuit portion every time new data is asserted on the data input. However, in some embodiments the data valid signal comprises an asserted data valid flag accompanied by a tick (e.g. a rising edge or a falling edge) of the first clock. For instance, if the first circuit portion wishes to stream data continuously to the second circuit portion for a period of time (i.e. with new data asserted on the data input data for every tick of the first clock), it may simply assert the data valid flag whilst it is streaming, with every tick of the first clock in this period of streaming comprising the assertion of a data valid signal.

In a set of embodiments, the shared memory comprises a ring buffer, with each data storage location corresponding to an element of the ring buffer. In such embodiments, the data storage portion may change the input data storage portion allocated as the input data storage location to the next element of the ring buffer in response to the data valid signal. Using a ring buffer may simplify the operation of the interface circuit.

The data storage portion may comprise any mechanism suitable for allocating and changing the allocated input data storage location. For instance, the data storage portion may comprise memory storing a pointer to the input data storage location in the shared memory (i.e. the currently-allocated input data storage location). This pointer may be changed in response to the detection of a data valid signal, to change the input data storage location. In some embodiments, the data storage portion comprises an incrementer configured to increment a counter value identifying the input data storage location in response to detection of the data valid signal. The incrementer may have a maximum counter value (e.g. defined by a bit size of the incrementer) equal to the number of data storage locations in the shared memory. In such embodiments the incrementer may inherently reset to an initial counter value when it is incremented after reaching the final data storage location in the shared memory (i.e. overflowing or wrapping to an initial value). It will be recognised that this may be a particularly convenient way to operate the shared memory as a ring buffer.

The data storage portion may comprise a demultiplexer configured to connect the data input to the data storage location allocated as the input data storage location (e.g. indicated by a counter value).

The data access portion may comprise any mechanism suitable for allocating and changing the allocated output data storage location. In some embodiments, the data access portion comprises memory storing a pointer to the output data storage location in the shared memory (i.e. the currently-allocated output data storage location). This pointer may be changed in response to the detection of the change of state of the interface signal, to change the output data storage location. In some embodiments, the data access portion comprises an incrementer configured to increment a counter value identifying the output data storage location in response to detection of the change of state of the interface signal. The incrementer may have a maximum counter value (e.g. defined by a bit size of the incrementer) equal to the number of data storage locations in the shared memory. In such embodiments the incrementer may inherently reset to an initial counter value when it is incremented after reaching the final data storage location in the shared memory.

The data access portion may comprise a multiplexer configured to connect the data storage location allocated as the output data storage location (e.g. indicated by a counter value) to the data output.

In some sets of embodiments, the data input comprises a plurality of parallel data lines and each of the plurality of data storage locations is configured to store a corresponding plurality of data bits. For instance, each data storage location may comprise a register with at least as many bits as the number of parallel data lines and preferably with an equal number of bits to the number of parallel data lines. The data input may comprise at least four parallel data lines, at least eight parallel data lines, at least sixteen parallel data lines, at least thirty two parallel data lines, at least sixty four parallel data lines, or even up to one hundred and twenty eight data lines or more. The use of parallel data lines and parallel data storage may allow the interface circuit portion to transfer large amounts of data, because multiple data bits can be transferred with each cycle of the first clock. This may be useful for streaming large quantities of data (e.g. image or video data) from the first clock domain to the second clock domain.

The second frequency may be at least 10% higher than the first frequency, at least 50% higher or at least twice the first frequency. In some embodiments the second frequency is at least 100 times higher than the first frequency or even 1000 times higher than the first frequency or more, e.g. 5000 times or 10000 times higher. In some embodiments, the first frequency is at least 1 MHz, at least 5 MHz, or at least 10 Mhz. In some embodiments the first frequency is less than 300 MHz, less than 200 MHz or less than 100 Mhz. In a set of embodiments the first frequency is between 5 Mhz and 156.25 MHz. In some embodiments the second frequency is at least 100 Mhz, at least 200 Mhz or at least 300 Mhz. In some embodiments the second frequency is less than 1 GHz, less than 750 MHz or less than 500 MHz. In a set of embodiments the second frequency is 320 Mhz.

In some embodiments, the signalling portion comprises a plurality of cascaded flip flops in the first clock domain. In one set of embodiments, the signalling portion comprises a first input flip flop that receives the data valid signal as an input and a second input flip flop that receives an inverted output of the first input flip flop as an input. In such embodiments the interface signal may comprise an output of the second input flip flop. This arrangement of flip flops produces a change of state in the interface signal in response to a data valid signal over two cycles of the first clock.

In some sets of embodiments, the data access portion comprises a plurality of cascaded output flip flops in the second clock domain, wherein a first output flip flop receives the interface signal as an input. The use of multiple cascaded output flip flops may avoid metastability in the interface signal. In some such embodiments, the data access portion is arranged to compare outputs of two adjacent output flip flops to detect a change of state in the interface signal. It will be recognised that in this arrangement the outputs of adjacent output flip flops will be different for one cycle of the second clock when a change of state in the interface signal has occurred. Preferably the data access portion is arranged to compare outputs of a final two output flip flops to detect a change of state in the interface signal. In some embodiments the data access portion consists of only two cascaded output flip flops. In other embodiments the data access portion consists of three cascaded output flip flops. This additional output flip flop may provide additional resilience against clock skew and/or physical variations in the first clock domain. This may be particularly useful in embodiments where the second frequency is significantly higher than the first frequency (e.g. more than 100 times higher or more than 1000 times higher).

The interface circuit portion disclosed herein is applicable to many applications where data is to be transferred between devices operating in different clock domains.

In a set of embodiments, the interface circuit portion is configured to facilitate the transmission of data from a camera system operating in the first clock domain to a data storage system operating in the second clock domain. For instance, the first circuit portion may comprise a camera device or a camera interface device (e.g. a Camera Serial Interface (CSI) handler). The second circuit portion may comprise a data storage device or a data storage interface device (e.g. a Direct Memory Access (DMA) handler).

The interface circuit portion may be provided as a physically separate device from the first and/or second circuit portions. Alternatively, the interface circuit portion may form part of the same device (e.g. an integrated circuit device) as one or both of the first and second circuit portions. For instance, the circuit system may comprise a host device integrated circuit, with the first circuit portion comprising a peripheral interface (e.g. a CSI handler) and the second circuit portion comprising a memory interface (e.g. a DMA handler).

Features of any aspect or embodiment described herein may, wherever appropriate, be applied to any other aspect or embodiment described herein.

Where reference is made to different embodiments, it should be understood that these are not necessarily distinct but may overlap. It will be appreciated that all of the preferred features of the interface circuit portion according to the first aspect described above may also apply to the other aspects of the invention.

One or more non-limiting examples will now be described, by way of example only, and with reference to the accompanying figures in which:

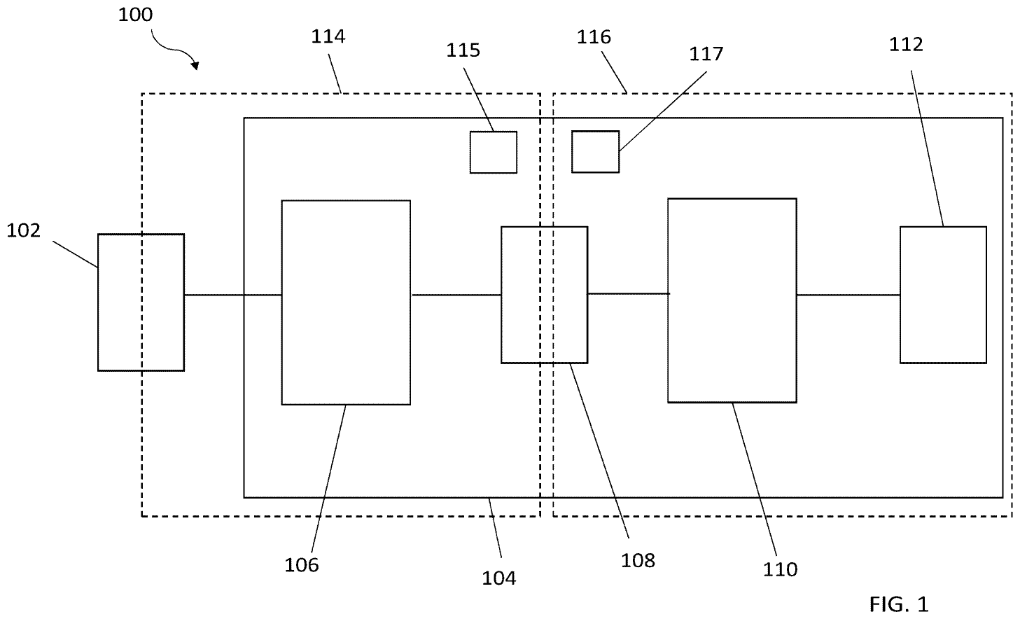

FIG. 1 is a schematic diagram of a camera system with an interface circuit portion according to an embodiment of the invention;

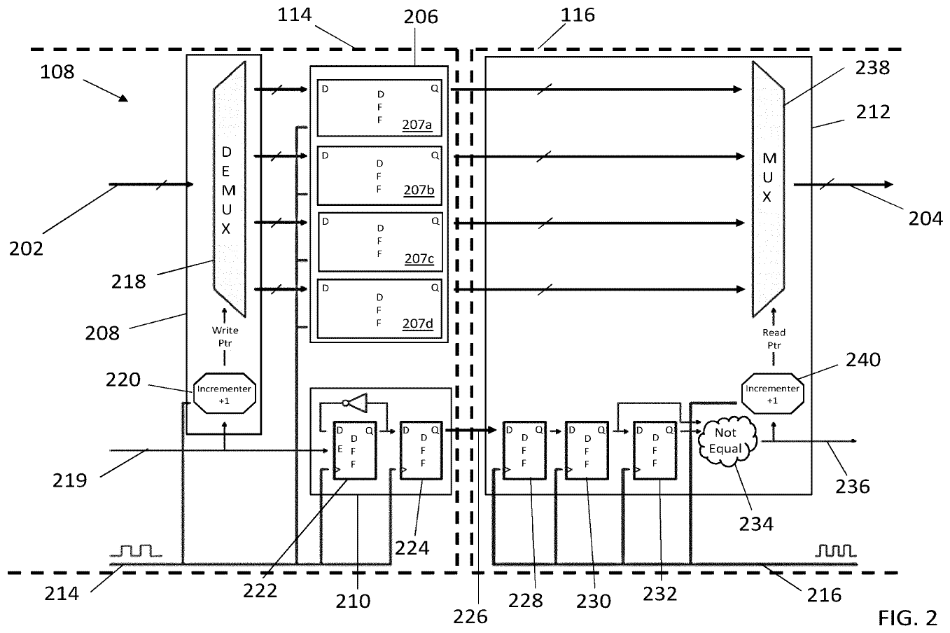

FIG. 2 is a more detailed schematic diagram of the interface circuit portion shown in FIG. 1; and

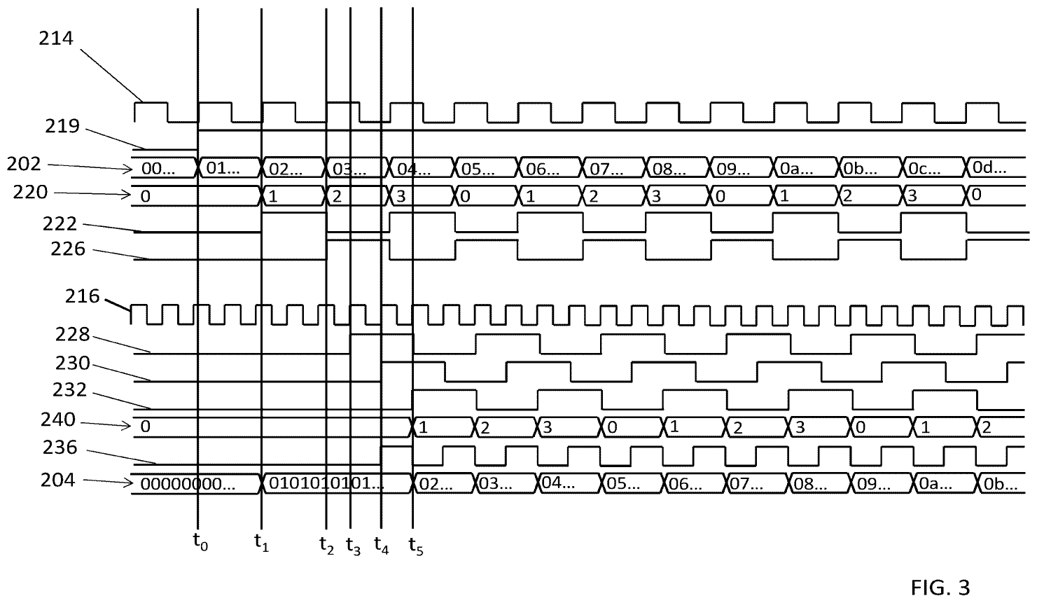

FIG. 3 is a timing diagram illustrating the operation of the camera system illustrated in FIGS. 1 and 2.

A camera system 100 is illustrated in FIG. 1. The camera system 100 comprises a camera 102 and a host device 104 (e.g. a personal computer). The host device 104 comprises a Camera Serial Interface (CSI) handler 106, a interface circuit portion 108, a direct memory access (DMA) handler 110 and a data memory 112. The CSI handler 106 comprises a physical interface (not illustrated) to which the camera is connected. The CSI handler 106 converts serial camera data received via the physical interface to a parallel format spread across 64 parallel data lines.

The CSI handler 106 operates in a peripheral clock domain 114 having a clock 115 with a first frequency. The first frequency is between 5 Mhz and 156.25 Mhz. The direct memory access handler 110 and the data memory 112 operate in an internal clock domain 116 having a clock 117 with a second, higher frequency. The second frequency is approximately 320 Mhz. The interface circuit portion 108 facilitates data transfer between the first and second clock domains 114, 116.

The interface circuit portion 108 is shown in more detail in FIG. 2. The interface circuit portion 108 comprises a data input 202, a data output 204, a shared memory 206, a data storage portion 208, a signalling portion 210 and a data access portion 212.

The shared memory 206, the data storage portion 208 and the signalling portion 210 are all clocked by a first clock signal 214 from the clock 115 which operates at the first frequency of the first clock domain 114. The data access portion 212 is clocked by a second clock signal 216 from the clock 117 which operates at the second, higher, frequency of the second clock domain 116.

The data input 202 comprises sixty four parallel data lines from the CSI handler 106. The shared memory 208 comprises four 64-bit registers 207a, 207b, 207c, 207d arranged as a ring buffer. The data storage portion 208 comprises a demultiplexer 218 controlled by a 2-bit input incrementer 220. The demultiplexer 218 directs the data input 202 to one of the four registers 207a, 207b, 207c, 207d according to the current counter value of the input incrementer 220. At any given time, one of the registers 207a-207d is allocated as the input data storage location by being connected to the data input 202 with the demultiplexer 218. The input incrementer 220 increments its counter value by one whenever new data is provided by the CSI handler 106, so incoming data is stored sequentially in the registers 207a-d. The shared memory 208 thus operates a register-based ring buffer.

In use, the data input 202 receives data from the CSI handler 106, with up to sixty four bits of data being received as often as every tick of the first clock signal 214. When new data is being asserted on the data input by the CSI handler 106, the CSI handler 106 asserts an input data valid flag 219. Each tick of the first clock signal 214 when the input data valid flag 219 is asserted is detected as an input data valid signal by the data storage portion 208, because it indicates that new data has been asserted on the data input 202 with that tick of the first clock signal 214.

The signalling portion 210 comprises two cascaded input flip flops 222, 224 which are both clocked by the first clock signal 214. The data input of the first input flip flop 222 is an inverted version of the data input of the second input flip flop 224.

The input data valid signal 219 is connected to an enable input of the first input flip flop 222. The output of the second input flip flop 224 is an interface signal 226 that is sent to the data access portion 212.

The data access portion 212 comprises a series of three cascaded output flip flops 228, 230, 232 that are all clocked by the second clock signal 216. The interface signal 226 propagates through the output flip flops 228, 230, 232 over three ticks of the second clock signal 216. The arrangement of the signalling portion 210 causes the interface signal 226 (the output of the second input flip flop 224) to change state with each tick of the first clock signal 214 when the input data valid signal 219 is asserted (i.e. for every occurrence of an update signal).

The data access portion 212 also comprises a comparison portion 234 which compares the outputs of the second and third output flip flops 230, 232 and asserts an output data valid signal 236 if the outputs of the second and third output flip flops 230, 232 are different. Thus, the output data valid signal 236 is asserted for one tick of the second clock signal 216 each time the interface signal 226 changes state.

The data access portion 212 comprises a multiplexer 238 controlled by a 2-bit output incrementer 240. The multiplexer 238 directs one of the four registers 207a, 207b, 207c, 207d of the shared memory 206 to the data output 204 according to the current value of the output incrementer 240. At any given time, one of the registers 207a-207d is allocated as the output data storage location by being connected to the data output 204 with the multiplexer 238.

The operation of the interface circuit portion 108 will now be described with reference to the timing diagram shown in FIG. 3.

At a time t₀, the CSI handler 106 begins to stream data to the data input 202, with sixty four bits of data being asserted with each tick of the first clock signal 214. The first set of data starts “01 . . . ”. The CSI handler 106 asserts the input data valid signal 219 and this remains high whilst the CSI handler continues to stream data. The data storage portion 208 thus detects an update signal (i.e. a tick of the first clock signal 214 when the input data valid signal 219 is asserted) with every tick of the first clock signal 214.

The initial counter value of the input incrementer 220 is 0, so the initial input data storage location (to which the first set of data is stored) is the first register 207a. At t₁, which is the next tick of the first clock signal 214 after the data began to be sent, the first set of data is stored to the first register 207a. At the same time, the data storage portion 208 detects an update signal and the input incrementer 220 increments its counter value by one. This changes the input data storage location to the second register 207b. The output of the first input flip flop 222 also goes high.

At the next tick of the first clock signal 214, the second set of data is stored to the second register 207b, and the updating process repeats. The output of the first input flip flop 222 goes low, and the output of the second input flip flop 224 (i.e. the interface signal 226) changes state from low to high.

The next tick of the second clock signal 216 after the interface signal 226 has changed from low to high is at t₃. At t₃, the output of the first output flip flop 228 goes high (because the interface signal 226 is high). On the next tick of the second clock signal 216, at t₄, this high signal propagates through to the output of the second output flip flop 230. The outputs of the second and third output flip flops are now different, and the comparison portion 234 outputs an output data valid signal 236 which indicates to the DMA handler 110 that there is new data at the data output 206.

The initial counter value of the output incrementer 220 is 0, so the initial output data storage location is the first register 207a. Thus when the output data valid signal 236 is asserted at t₄, the data output 204 outputs the first set of data (“01 . . . ”) stored in the first register 207a.

On the next tick of the second clock signal 216, at t₅, the output incrementer 240 increments its counter value by one, so the output data storage location is changed to the second register 207b (which in the meantime has stored the second set of data “02 . . . ”).

Because the second clock signal 216 runs at a higher frequency than the first clock signal 214, the next change of state of the interface signal 226 (caused by the next set of data being asserted at the data input 202) has not yet reached the second output flip flop 230 at t₅. The second and third output flip flops 230, 232 are therefore outputting the same state and the output data valid signal 236 goes low.

This process repeats on the input and output sides of the interface circuit portion 108, with new data being stored to successive registers 207a-207d and the interface signal 226 changing state to indicate to the data access portion 212 when the new data has been received. The counter values of the input and output increments 220, 240 are incremented in synchrony as new data arrives (although not at exactly the same time), continually keeping track of where incoming data is to be stored and where outgoing data should be accessed.

The four registers 207a-207d of the shared memory 206 act as a buffer for incoming data, to allow enough time for the state of the interface signal 226 to be changed and for this change of state to be processed by the data access portion 212. Because the indication of new data to the data access portion 212 is a change of state, the data access portion 212 does not need any information about the phase or frequency of the first clock signal 214 to operate reliably.

The interface circuit portion 108 thus enables fast and reliable transfer of data from the first clock domain 114 to the second clock domain 116 without the need for handshake procedures or large dual-port RAM.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A system comprising:
a first circuit portion operating in a first clock domain with a first clock having a first frequency;
a second circuit portion operating in a second clock domain with a second clock having a second, higher, frequency; and
an interface circuit portion for transferring data from the first circuit portion to the second circuit portion, the interface circuit portion comprising:
a data input arranged to receive data from the first circuit portion;
a data output arranged to provide data to the second circuit portion;
a shared memory comprising a plurality of data storage locations, at any given time one of said data storage locations being allocated as an input data storage location and one of said data storage locations being allocated as an output data storage location, wherein the shared memory is configured to store data asserted at the data input to the input data storage location, and to provide data stored at the output data storage location to the data output;
a data storage portion;
a signalling portion; and
a data access portion;
wherein:
the first circuit portion is arranged to assert data at the data input and to assert a data valid signal when asserting data at the data input;
the data storage portion is configured to detect the data valid signal and to change the input data storage location in response to the data valid signal;
the signalling portion is configured to generate an interface signal and to change a state of said interface signal in response to the data valid signal; and
the data access portion is configured to detect the change of state of the interface signal, to change the output data storage location in response to the change of state of the interface signal and to output a data ready signal to the second circuit portion in response to the change of state of the interface signal.

2. The system of claim 1, wherein the number of data storage locations comprised by the shared memory corresponds to a propagation delay between the data valid signal being asserted and the change of state of the interface signal being detected by the data access portion.

3. The system of claim 1, wherein the shared memory consists of four storage portions.

4. The system of claim 1, wherein the shared memory comprises a ring buffer, with each data storage location corresponding to an element of the ring buffer.

5. The system of claim 1, wherein the data storage portion comprises an incrementer configured to increment a counter value identifying the input data storage location in response to detecting the data valid signal.

6. The system of claim 1, wherein the data storage portion comprises a demultiplexer configured to connect the data input to the data storage location allocated as the input data storage location.

7. The system of claim 1, wherein the data access portion comprises an incrementer configured to increment a counter value identifying the output data storage location in response to detection of the change of state of the interface signal.

8. The system of claim 1, wherein the data access portion comprises a multiplexer configured to connect the data storage location allocated as the output data storage location to the data output.

9. The system of claim 1, wherein the data input comprises a plurality of parallel data lines and each of the plurality of data storage locations is configured to store a corresponding plurality of data bits.

10. The system of claim 9, wherein each data storage location comprises a register with an equal number of bits to a number of parallel data lines.

11. The system of claim 1, wherein the signalling portion comprises a first input flip flop configured to receive the data valid signal as an input and a second input flip flop configured to receive an inverted output of the first input flip flop as an input.

12. The system of claim 1, wherein the data access portion comprises a plurality of cascaded output flip flops in the second clock domain, wherein a first output flip flop is configured to receive the interface signal as an input.

13. The system of claim 12, wherein the data access portion is arranged to compare outputs of two adjacent output flip flops to detect a change of state in the interface signal.

14. The system of claim 12, wherein the data access portion consists of three cascaded output flip flops.

15. The system of claim 1, wherein the second circuit portion is arranged to access data at the data output in response to the data ready signal output by the data access portion.

16. The system of claim 1, wherein the first circuit portion comprises a camera device.

17. The system of claim 1, wherein the second circuit portion comprises a data storage device.

18. The system of claim 1, wherein the first circuit portion comprises a camera interface device.

19. The system of claim 1, wherein the second circuit portion comprises a data storage interface device.
